(19) United States
(12) Patent Application Publication
(10) Pub. No.: US 2014/0081722 A1
(43) Pub. Date: Mar. 20, 2014

(54) SYSTEMS AND METHODS FOR ELECTRONIC COUPON OPTION PURCHASE AND USE

(71) Applicant: Brian Schacht, New Richmond, WI (US)

(72) Inventor: Brian Schacht, New Richmond, WI (US)

(21) Appl. No.: 14/026,557

(22) Filed: Sep. 13, 2013

Related U.S. Application Data
(60) Provisional application No. 61/701,032, filed on Sep. 14, 2012.

(51) Int. Cl. G06Q 30/02

(52) U.S. Cl. CPC G06Q 30/0213
USPC 705/14.15

(57) ABSTRACT

A system and method for internet-enabled retailing and redemption of coupon options; retailer-sold, consumer purchasable discounts for goods or products. The system may include a coupon option server receiving coupon option information including a purchase price, discount, and the underlying good. The coupon option is displayed on a coupon option website where it may be searched, reviewed, purchased by and delivered to a consumer. The consumer may then present the coupon option at a retail point of sale for redemption. A retailer site may also be equipped with a wireless broadcast device to broadcast coupon options to consumer smartphones for purchase by the consumers.

### CROSS-REFERENCE TO RELATED APPLICATIONS

The present application claims the benefit of U.S. Provisional Application No. 61/701,032, filed Sep. 14, 2012, entitled “System And Method For Coupon Options”.

### BACKGROUND OF THE INVENTION

The present invention generally relates to an internet-enabled retailing system. More particularly, the present invention relates to an internet-enabled retailing system that provides incentives to consumers.

Retailers or other sellers of goods typically employ a host of methodologies to drive sales and incentivize consumers to purchase goods or services. One incentivization tool that has been long employed is for the retailer to offer a discount to the purchase of their goods. Another incentivization tool is a loyalty program that may offer a reduced rate or discount for the purchase of goods or services.

However, retailers are typically limited in the amount of discount that they can offer to a consumer because too great of a discount may adversely impact the retailer profitability. On the other hand, loyalty programs may not be attractive to consumers because they may require a significant amount of a product or service to be purchased before the consumer is entitled to a significant discount.

### BRIEF SUMMARY OF THE INVENTION

One or more embodiments of the present invention provide internet-enabled retailing and redemption of coupon options which are retailer-sold, consumer purchasable discounts for goods or products. In one embodiment, a coupon option server receives coupon option information including a purchase price, discount, and the underlying good. The coupon option is displayed on a coupon option website where it may be searched, reviewed, purchased by and delivered to a consumer. The consumer may then present the coupon option at a retail point of sale for redemption. A retailer site may also be equipped with a wireless broadcast device to broadcast coupon options to consumer smartphones for purchase by the consumers.

### BRIEF DESCRIPTION OF THE DRAWINGS

FIG. 1 illustrates a system for electronic coupon option purchasing according to one embodiment of the present invention.

FIG. 2 illustrates a system for electronic coupon option transaction modification according to an embodiment of the present invention.

FIG. 3 illustrates a system for wireless broadcast and purchase of coupon options.

FIG. 4 illustrates the operation of a card-based coupon option management system.

### DETAILED DESCRIPTION OF THE INVENTION

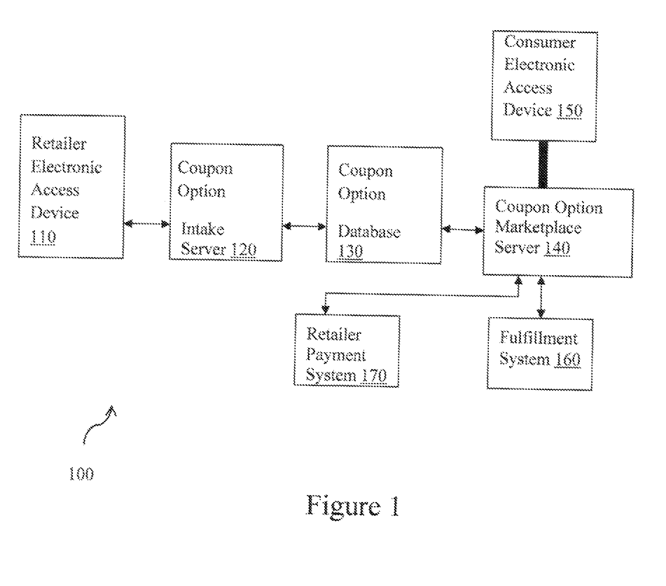

FIG. 1 illustrates a system for electronic coupon option purchasing 100 according to one embodiment of the present invention. The system for electronic coupon option purchasing 100 may also be known as a ‘Coupon option’ purchasing system. As shown in FIG. 1, the system 100 includes a retailer electronic access device 110, an coupon option intake server 120, a coupon option database 130, a coupon option marketplace server 140, a consumer electronic access device 150, a fulfillment system 160, and a retailer payment system 170.

As further described below, a coupon option is a purchased right to a specified discount in the purchase price of goods or services, such as a dollar or percentage discount. The electronic coupon option purchasing 100 is allows a retailer to list coupon options for sale and allows the coupon options to be purchased by consumers for later redemption at the retailer.

In operation, a retailer uses the retailer electronic access device 110 to communicate with the coupon option intake server 120. At the coupon option intake server 120 a coupon option application provides the retailer with selectable parameters for establishing a coupon option. In one embodiment, the selectable parameters include: a product name, a text and/or graphical description of the product, the retail price of the good for which the coupon option is being offered, the amount of the coupon option discount in dollars or percentage, and the purchase price of the coupon option.

Alternatively, the retailer may be selling and listing coupon options for services in addition to or instead of goods or products. Additionally, the retailer may identify the product and/or type by uploading a textual or graphical description to the coupon option intake server 120 or by providing a link to the retailer's website. In another embodiment, the retailer may identify the product and/or type by providing a link to the retailer's product database.

Additional selectable parameters for establishing the coupon option include: a time and/or location where the coupon option will be honored by the retailer, a start time for the offer to appear on the coupon option marketplace server 140, and a ending time or total number of coupon options sold at which time the coupon option offer is to be removed from the active offers section of the coupon option marketplace server 140.

Once the parameters of the coupon option are selected, the application provides the retailer with the opportunity to confirm the terms of the coupon option.

The application also preferably provides an indication of the cost of offering the coupon option. In one embodiment, the cost includes a membership fee, licensing fee, and/or listing fee which may be fixed of vary based on quantity of coupon options offered or the cost of the underlying good. Additionally, the cost may include a percentage of the sales proceeds of the coupon option, either anticipated or actual.

Once the retailer is satisfied with the coupon option terms and pricing, the retailer activates a confirmation through the coupon option application and the coupon option is added to the coupon option database 130

In one embodiment, the coupon option database 130 is a database of all coupon options that have been entered by retailers in the coupon option purchasing system 100. The coupon option database 130 is preferably indexed to support quick retrieval of a coupon option selected for display by the coupon option marketplace server 140 or selected by a consumer electronic access device 150. For example, the database may be indexed by price, retailer, geographic location, and subject, and/or by percentage of savings.

Turning now to the coupon option marketplace server 140, the coupon option marketplace server 140 serves a website and accompanying consumer application to allow consumers to purchase coupon options. In one embodiment, a consumer may activate a consumer electronic access device 150 such as a personal computer, smartphone, tablet, or other internet-enabled device and use a browser on the device to retrieve the website served by the coupon option marketplace server 140. In another embodiment, the consumer electronic access device 150 may also be a point-of-sale device such as an internet-enabled kiosk or other dedicated device.

Once the consumer electronic access device 150 contacts the coupon option marketplace server 140, the consumer application displays an initial welcome page. The initial welcome page may display a plurality of coupon options available for purchase. One or more pages of the website may also display the coupon options available for purchase broken down into one or more categories such as price, type of good or service, location, and/or coupon option redemption time. Additionally, the website may over a consumer-selectable filter through the consumer application which may allow the consumer to select or unselect filters to apply to the available coupon options, for example to narrow or target the consumer's search. Additionally, the welcome page also includes a search query entry which may allow the consumer to search for a specific retailer, good or service, and/or price.

In one embodiment, the consumer enters the search parameters through the consumer electronic access device 150 and the search parameters are relayed to the coupon option marketplace server 140. The coupon option marketplace server 140 then retrieves the available coupon options from the coupon option database 130 and applies the search parameters to determine the most relevant coupon options to return as search results. The most relevant coupon options are then displayed by the coupon option marketplace server 140 on the website for view by the consumer.

The consumer then selects a desired coupon option and moves it to a shopping cart for checkout. The coupon option marketplace server 140 then allows the consumer to checkout, for example by receiving credit card information from the consumer and charging the credit card.

Once the payment has been successfully processed or at the time that payment is processed, the coupon option marketplace server 140 may present the consumer with several selections for delivery of the coupon option. A first selection may be electronic delivery of the coupon option to a consumer device, similar to the Amazon gift certificate electronic delivery process in which a code is simply e-mailed to the consumer electronic access device 150. The code may also be a bar code or a QR code.

A second selection may be physical fulfillment using the fulfillment system. In this selection, the coupon option marketplace server 140 transmits the coupon option parameters to the fulfillment system 160 and the fulfillment system generates a physical magnetic stripe card and sends it to the consumer's address, such as the mailing address entered by the consumer as part of the credit card payment process.

Additionally, after processing the consumer's payment, the coupon option marketplace server 140 also sends a portion of the consumer's payment to the retailer's payment system 170. For example, where the consumer has purchased a coupon option for $10, the coupon option marketplace server 140 may receive the $10, retain $1 as a fee and credit the remaining $9 to the retailer payment system 170. In some embodiments, the retailer's payment system 170 may be a bank or an electronic payment receiving system, or the retailer's payment system 170 may be a physical check or electronic funds transfer. Additionally, the payment may alternatively be made directly to the retailer by check or electronically. Alternatively, the payment may be made to a PayPal account, Square account or some other alternative payment service.

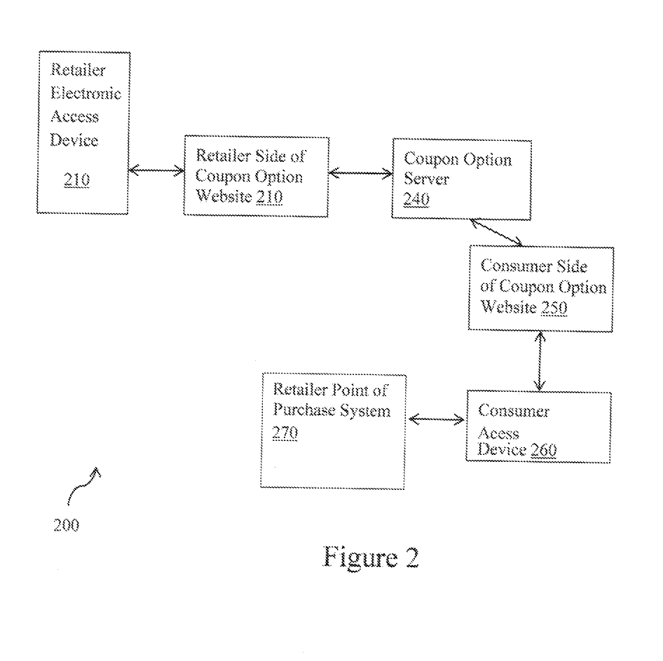

FIG. 2 illustrates a system for electronic coupon option transaction modification 200 according to an embodiment of the present invention. First, as described above with regard to FIG. 1, a retailer may use the retailer electronic access device 210 to access a retailer side of the coupon option website 210. There, the retailer uses the retailer electronic access device 210 to electronically enter into an agreement to offer a coupon option for a specific product to consumers.

In the example of FIG. 2, the product is pair of jeans which normally retails for $50 per pair. Thus the retailer uses the retailer electronic access device 210 to interact with the retailer side of the coupon option website 210 which stores the coupon option created by the retailer on the coupon option server 240. The coupon option server 240 then allows the coupon option to be displayed or offered to the consumer on the consumer side of the coupon option website 250. As discussed above, the price for the coupon option is determined by the retailer and may be $8 in the example of FIG. 2.

As recited above, the consumer searches the consumer side of the coupon option website 250 using the consumer access device 260. In one example, the consumer may be looking for a specific product or product type such as a specific brand of jeans or jeans generally. The consumer's search is then transmitted from the consumer access device 260 to the consumer side of the coupon option website 250. The consumer side of the coupon option website 250 then interacts with the coupon option server 240 to pass the consumer's search to the coupon option server 240. The consumer side of the coupon option website then receives the search results from the coupon option server 240 and relays them to the consumer access device 260.

The consumer may then use the consumer access device 260 to select and purchase one of the coupon options as discussed above. In this example, the consumer may purchase for $8 a coupon option that gives the consumer the ability to purchase a certain pair of jeans that typically retails for $50 for a reduced price of $27 during a time frame specified by the retailer which may be 90 days for example. Other time frames may include 1 day, 3 days, 10 days, 30 days, 60 days, 120 days, one year, and unlimited time frames. The coupon option may them be downloaded to the consumer access device 260.

In order to use or redeem the coupon option, in one embodiment the consumer access device 260 is a personal computer and the consumer uses the personal computer to print a paper with a bar code representing the coupon option. The consumer may then transport the paper with the bar code to the retailer's site. At the retailer's site, the retailer point of purchase system 207 may include an optical scanner that may scan and decode the bar code. The discount represented by the coupon option may then be used to modify the standard transaction of purchasing the jeans for $50 to become a transaction of purchasing the jeans for $27.

In another embodiment, a digital copy of the coupon option, such as a graphic file that displays a barcode when activated, may be downloaded and stored on a mobile device, for example when the consumer access device 260 is a mobile device. The consumer may then travel to the retailer's site and activate the mobile device to display the graphic file with the bar code. The bar code may then be scanned at the retailer point of purchase system 270 and applied as discussed above.

In a third embodiment, the coupon option may be embodied as a digital code, such as an alphanumeric code that may be downloaded to the consumer access device. The coupon option may then redeemed by entering the digital code in a point of purchase system 270 at the retailer, similar to entering a code during a typical debit card transaction. The coupon option may then be applied as discussed above to modify the transaction.

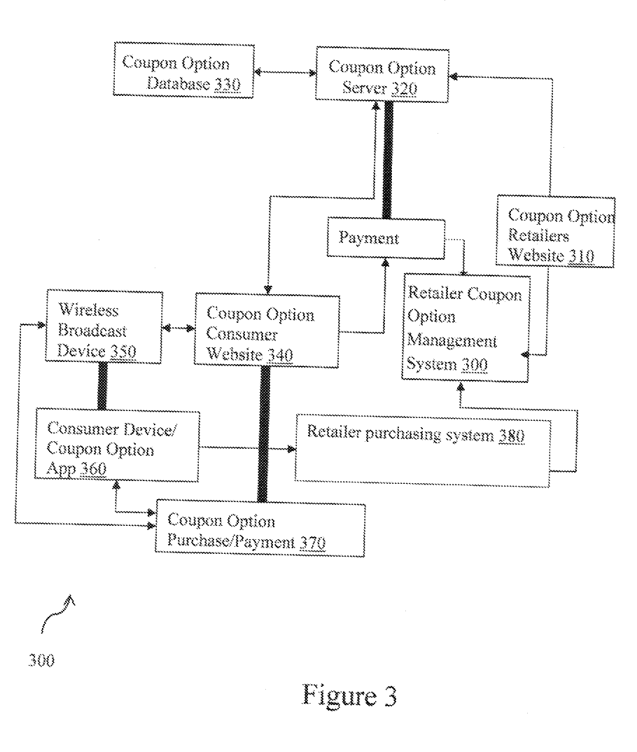

FIG. 3 illustrates a system 300 for wireless broadcast and purchase of coupon options. In FIG. 3, the retailer uses a retailer coupon option management system 300 to communicate that the coupon option retailers website 310, which runs an application allowing the retailer to set the parameters for a desired coupon option as discussed above. The coupon option is then finalized and transmitted to the coupon option server 320 and stored in the coupon option database 330. The coupon option is also transmitted to the coupon option consumer website 340.

In one embodiment, the coupon option consumer website 340 includes connection with a wireless broadcast device 350 located at the premises of the retailer. The wireless broadcast device 350 receives one or more coupon options from the coupon option consumer website 250 and broadcasts the coupon option inside and/or near the retailer's store.

The broadcast coupon option is then received by a consumer device when a consumer brings the consumer device within range of the wireless broadcast device 350. The consumer device then receives and downloads the coupon option for display to the consumer.

In one embodiment, the consumer device may be a smartphone running an application that is designed to receive coupon options from wireless broadcast device 350. Thus, when a smartphone with the application loaded and activated enters the retailer's store, the application automatically detects the wireless broadcasting device and notifies the consumer of the active coupon option offers available that day in this particular store, for example by using a graphical or textual display on the screen of the smartphone and/or by causing the smartphone to ring or vibrate.

The graphical display not only identifies the coupon option, it allows the consumer to navigate between coupon options (when more than one is broadcast) and may also direct the smartphone's web browser to the coupon option consumer website 340 where additional coupon options may be stored for display to the consumer.

Additionally, once the user has selected a coupon option, the graphica display causes a “buy” button to be displayed. The consumer can then click on the “buy” button, to purchase the coupon option. The coupon option may then be provided to the consumer using any of the modalities described herein. In one example, the coupon option is provided to the consumer by transmitting a code from the coupon option consumer website 340 through the wireless broadcast device 350 to the consumer device 360. Alternatively, the coupon option may be provided to the consumer device using the consumer's owns wireless service through a third party provided.

When the consumer purchases a coupon option, payment for the coupon option may be made by the consumer through the coupon option consumer website 340, for example by credit card or debit card. The coupon option consumer website 340 may include a merchant account for accepting credit cards, debit cards, and/or other electronic payment transfers. Payment received by the coupon option consumer website 340 may then be transferred and/or electronically credited to the coupon option server 320. The coupon option server 320 may then split the payment between the retailer and the coupon option system owner as described above.

The consumer may then approach the retailer purchasing system 380 to purchase the good while using the coupon option that they have just purchased. For example, the consumer may provide the coupon option code that was downloaded to their smartphone to a cashier at the retailer purchasing system 380. The retailer purchasing system 380 then interprets the coupon option code as a discount to be applied to the purchase of the goods and displays the appropriate discount for the cashier. The discount is then applied to the purchase price and payment for the discounted price is received from the consumer.

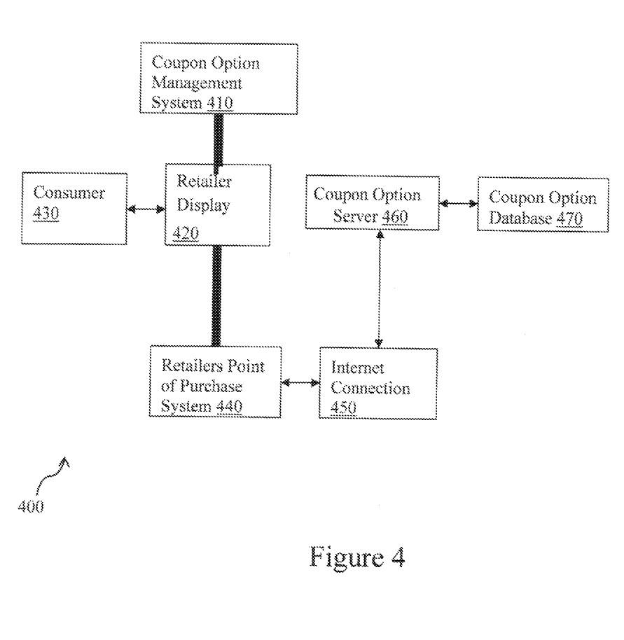

FIG. 4 illustrates the operation 400 of a card-based coupon option management system. In FIG. 4, the coupon option management system 410 receives a large number of coupon option electronic cards. In one embodiment, the coupon option electronic cards may be a plastic card with a magnetic data strip, similar to a loyalty card or a debit card. The coupon option electronic cards include data in the magnetic strip uniquely identifying each individual card.

The cards may then be displayed in the retailer display 420 for activation or purchase by consumers. As discussed above, purchase of the coupon option entitles the purchaser to receive a discount upon presentation of the card at the time of a purchase of a specific product. In one embodiment, the card may be pre-associated with a certain coupon option offer, such as buy a graphical display on the card. The consumer may then bring the card to the retailer's point of purchase system 440 and pay for the coupon option. The retailer may then receive the unique identifier of the card, associate the unique identified with a specific coupon option, and then relay the associated unique card identifier and coupon option through the internet connection 450 to the coupon option server 460 for storage in the coupon option database 470.

In another embodiment, the card may be generic and may be loaded with any specific coupon option selected by the consumer and then paid for at the retailer's point of purchase system 440. For example, the retailer may include a kiosk on site that includes an internet connection to the coupon option consumer website. A consumer may review available coupon options on the consumer website and select a desired coupon option. The kiosk may be pre-loaded with cards and then select a specific card and associate the card's unique identification with the chosen coupon option. As above, the associated identifier and coupon option may then be relayed to the coupon option database.

In one embodiment, when the consumer presents a pre-purchased card with a stored coupon option for the discount, the retailer may swipe the card through their point of purchase system 440. The point of purchase system 400 preferably includes software that controls a card reading machine, a card scanner, transaction detail collecting and transmitting equipment, a register, and a computer with specific software for point of purchase applications which may all collectively make up the point of purchase system. Once a card is presented, the point of purchase system 440 may communicates through an internet connection or phone line connection to the coupon option server 460. The Coupon option server 460 may comprised a computer with a CPU, memory, hard drives, a network card or modem, servers and coupon option operating software. The coupon option server thus receives the card's identifier and searches the coupon option database 470 for a match. When a match is found, the coupon option associated with the identifier is returned to the retailer's point of purchase system 440. If a match is not found, then a failure indicator is returned to the retailer's point of purchase system 440. The coupon option associated with the card may then be applied to a purchase by the consumer.

In one embodiment, multiple coupon options are associated with a single card, when a coupon option associated with a card is activated by a user purchase, an identification of the card's unique identifier and the specific coupon option is then passed to the coupon option server 460. The coupon option server 460 then retrieves the data connected to the card from the coupon option database and removes the association of the exercised coupon option from the unique card identifier. The remaining coupon options associated with the unique identifier remain associated with the unique identifier and continue to be stored in the coupon option database 470.

In one embodiment, a single coupon option may be usable for multiple purchases. In this embodiment, the coupon option that is associated with the card identifier includes a numeric index identifying the number of purchases for which the coupon option may be used. As each purchase is made, the number identifier is decreased until the final purchase is made at which time the coupon option is removed from association with the card identifier.

In one embodiment, a single coupon option may be usable for a quantity of goods rather than a specific number of purchase transactions. In this embodiment, the coupon option is associated with a numeric index identifying the quantity of goods for which the coupon option is valid. As the consumer purchases goods, the retailer's point of purchase system 440 sends data to the coupon option server 460 identifying the quantity of goods purchased by the consumer. The coupon option server 460 then decrements the numeric index by the number of goods purchased. Once the numeric index reaches zero, the coupon option is removed from association with the card identifier.

In one embodiment, the retailer's point of purchase system may also be used to reload a coupon option that has been partially or totally depleted by a consumer. In one embodiment, reloading the card may be similar to purchasing a new coupon option for an existing card. The new or reloaded coupon option may then be associated with the card's identifier and stored in the coupon option database 470.

In one embodiment, a coupon option management system may be purchased by a gasoline retailer. The gasoline retailer may then be able to advertise the larger-then-normal discounts that are obtainable by using a coupon option. More specifically, consumers may purchase a coupon option gas card with a magnetic strip that stores data. In one embodiment, the magnetic strip may store a unique identifier that may be associated with a number of gallons of fuel and then stored in the coupon option database. In another embodiment, the magnetic strip may store a quantity of fuel, such as a number of gallons, represented by the coupon option.

In one embodiment, the retailer may market a coupon option providing a $0.12 discount per gallon on fuel for 100 gallons and may sell the coupon option to consumers for $6. The consumer may be incentivized to purchase the coupon option because the consumer receives $12 worth of gas when the coupon is purchased for $6 and all 100 gallons of the coupon option are purchased—a net gain to the consumer of $6 on the purchase of 100 gallons of gas. The retailer may also be incentivized to sell the coupon option in order to induce the consumer to purchase gas solely from the retailer. Additionally, in one embodiment, the retailer receives the entire $6 proceeds of the sale of the coupon option up front, but has not yet had to provide any gas. Additionally, it may take the consumer some time to purchase and consume the 100 gallons of gas, which provides the retailer with a benefit due to the time value of money. Additionally, a number of consumers are likely to misplace or otherwise not be able to exercise their coupon options. This embodiment may apply, for example, when the retailer paid a one-time fee for the installation of the coupon management system. In another embodiment, the retailer may split the $6 proceeds of the sale of the coupon option with the operator of the coupon option management system

In one embodiment, once the consumer purchases the coupon option, the coupon option savings is only applicable when the consumer presents the coupon option gas card at the time of sale, so that the coupon option gas card may be debited for the quantity of gallons purchased through the retailer's point of purchase system. The consumer is then credited the $0.12 per gallon savings and then proceeds to pay for the remaining amount using the consumer's preferred payment medium. Thus, the consumer may obtain the $0.12 discount when presenting the coupon option card at the point of purchase so long as the coupon option card has remaining gallons of fuel on the card. When the card is empty, then the consumer may purchase an additional card.

Thus, the consumer reaps the benefit of saving on each fuel purchase. Additionally, by selling the coupon option card, the retailer benefits from the strong incentive for the consumer to only purchase fuel at their store, and by the requirement that the consumer enter the store and present the card to receive the discount, which increases the potential for additional in store sales.

Additionally, in one embodiment, the retailer may have an exclusive right to use the coupon option system in their market area, which may provide the retailer with a strong competitive advantage over other retailers, thus driving sales for the retailer. The gasoline retailer is thus the only store that may market the coupon option system, which provides a discount where a percentage of the cost of the discount is offset by the sale of the discount.

Thus, in one embodiment of FIG. 4, the coupon option management system 410 is provided to a retailer display 420 at a retailer. The retailer then is able to market the coupon option system and sells a discount to the consumer 430 in the form of a debit type card with a magnetic stripe. To activate the card upon purchase by the consumer, the retailer swipes the card through the Point of Purchase system 440, which communicates with the Coupon option Server 460 through the Internet Connection 450, the Server 460 searches the Database 470 and authenticates and activates the card with a specific quantity or value. When the Consumer 430 presents the card for a discount on a purchase to the Retailer 420 swipes the card thought the Point of Purchase System 440, which communicates with the server 460 through the internet connection 450 and the server searched the database 470 for authentication of the card and authorization for the discount. The authorization is then sent back through the server, internet connection to the Point Of Purchase which allows the Retailer to accept the discount.

In one or more embodiments of FIG. 4, the coupon option management system 410 may provide one or more of the following: the sale of discount and right to a discount to consumers; a medium to embody the discount, such as a plastic card with magnetic strip holding data, digital or paper certificate with a code or pin; a marketing system or method where the retailer sells the Coupon option card to the consumer and through the sale of the card is obligated to sell specific goods to the consumer for a set discount off the advertised price; a pricing system or method where the retailer offsets the cost of the discount by the revenue generated from the sale of the Coupon option card to the consumer; a discounting system or method where the sale of the Coupon option card allows the retailer to collect money up front in exchange for the Coupon option card which allows the card holder a larger than normal discount for a set volume of future purchases; a discount where the purchaser of the Coupon option card receives a specific discount when submitting the Coupon option card to the retailer at the point of purchase.

Additionally, in one or more embodiments of FIG. 4, the coupon option management system may be used to predict future sales. For example, purchase of a coupon option has a positive correlation that the purchaser will spend a certain amount on gas during a certain time period subsequent to purchasing the coupon option. Consequently, once the coupon option management system has been established, an increase or decrease in the periodic purchasing of coupon options likely has a positive correlation to a respective increase or decrease in the consumption of gasoline in the near future. Thus, in one embodiment, FIG. 4 may be applied to a system and method of predicting future sales and ensuring customer loyalty by the sale of the Coupon option card which gives strong financial benefit and incentive to the card holder for future sales with the retailer until a specific amount of goods is exchanged.

In a more general sense, a coupon option may be conceptualized as follows. Retailers currently market their good and services as represented by this common formula for a sale in today market place:

B−C−D=A

Where A is profit, B is the list price of a product, C is the amount of discount given away for free to entice consumers, and D is the wholesale cost.

However, using a coupon changes this basic formula into

B−C−D+E=A

Where A, B, C, and D are the same as above, but E is the amount of the sale proceeds from the sale of the coupon option.

Thus, currently retailers market their products through coupons, loyalty program discounts, or sales promotions where the consumer is simply given a discount. However, because the retailer is giving away the discount they are limited on the size of the discount they may offer and still make a profit on the goods they sell. With the coupon option system, the retailer for the first time is able to market unusually large discounts which incite larger than normal consumer interest and retail sales because of the size of the discount offering. The retailer still retains profitability on the goods being sold because the retailer does not give this discount away, instead the retailer sells the discount or the right to the discount to the consumer. The retailer then is able to use the proceeds from the sale of the discount to offset the cost (to the retailer) for the discount.

In one embodiment, the coupon option system may be a program to market and sell coupon options on a website through an online consumer account, directly through the coupon option app, for the retailer to sell coupon options directly to the consumer, or for an automatic offer through a retailer's wireless network device which automatically communicates with a consumer device through the coupon option application.

In one embodiment, selling coupon options benefits retailers by allowing retailers a competitive advantage in inciting sales by marketing larger than normal discounts and selling the discount on a good or service to the consumer, and using the proceeds of the discount to offset the cost of the discount. This creates a competitive advantage by allowing the retailer to advertise prices that the competition can't afford to match without selling a discount. The retailer may sell a discount or the right to a discount for use immediately or into the future. In a delayed sale environment, coupon options also allow the retailer to forecast sales based on the sale for coupon options that are only redeemable during a specific time, for example coupon options redeemable days, weeks, or months into future.

The delayed sales allow the retailer to hedge against price increases by using the forecast created through the sales of coupon options to order larger than normal volumes of goods based on the forecasted sales which in turn should allow for a lower acquisition price for the retailer. Coupon options allows retailers to market their products and services in a new and unique way to consumers and created a competitive advantage because the retailer may afford to market lower prices and larger discounts than the non-licensed retailer who without the license cannot sell the discount to offset the cost of the discount.

Coupon options benefit consumers by allowing the consumer to purchase goods, services, and tickets at reduced prices not normally available on the open market, without having to participate in a group sale (such as Groupon) to receive a specific price. Consumers may purchase a coupon option and lock in a guaranteed price or discount during a specific time on a specific quantity of product.

With regard to delivery, coupon options may be available to be searched and purchased by a consumer while logged into the consumers account on the coupon option website, through the coupon option application, through coupon option promotional email using a computer, tablet, smart phone, or other mobile device, or direct through a retail merchant. Consumers may receive a coupon option card with a magnetic strip or will save a digital certificate containing a code or save a paper copy of coupon option with a barcode or authorization code which tracks the validity of the coupon option. The barcode or authorization code or coupon option card is scanned or entered through the retailers Point of Purchase system when the consumer exercises the coupon option at the retailer's store. Coupon options may also be able to be saved on a mobile device through the coupon option app and the coupon option barcode or authorization code that is scanable from the mobile device, smart phone, or tablet screen by the retailer at the time the consumer exercises the coupon option, or the codes may be entered into the retailers Point of Purchase system like a pin code for a debit card transaction. Coupon option magnetic strip cards may also be sold in a retail environment and may be used to redeem a coupon option offer by swiping the card through the retailers Point of Purchase system similar to a debit or credit card transaction.

Additionally, coupon options may be integrated by internet feed to the retailers or into the retailers computer database, servers, or Point Of Purchase system which may activate and make “live” each barcode from a purchased coupon option, and allow the consumer to exercise their coupon option at the retailers location or website. Coupon option cards may be integrated through a card swipe machine at a Point Of Sale system.

Coupon options may, for example, vary by sales price, amount of discount, expiration date, initial redemption date, and product quantity thereby allowing unique marketing and incentives to engage consumers and drive sales.

In another embodiment, a coupon option may be a contractual agreement giving the purchaser the ability to purchase a specific good, service, or event at a specific price during a specific time. The discount or right to a discount may be sold in the form of digital or paper certificate, or a plastic magnetic strip card like a credit or debit card, which may be sold to a consumer and contractually obligates the seller to deliver a good, service, or event at a specific price or specific discount at the consumers redemption during a specific time period.

In one embodiment, coupon options provide a marketing and sales system or process that allows retailers of consumer goods, services, or events to enter into a contract with consumers which allow the retailer to incite sales by selling a discount on a good, thereby allowing the retailer to profit from the sale of the discount and gain a competitive advantage by marketing and selling goods at larger discounts than would be possible if the discount was given away and the proceeds from the sale of the discount were unavailable to offset the discount. Coupon options allow consumers the ability to purchase consumer goods, services and events at reduced prices not normally available on the open market and the ability to lock in prices for good, services, or events for future use.

Additionally, the use of coupon options may provide price advantages to retailers by using the sales proceeds from selling a discount to offset the discount; unmatchable discounts that are not affordable by retailers without using the proceeds from the sale of the discount to offset the discount; customer loyalty by selling a discount card that entitles the holder to future discounts on future purchases; inciting future purchases by the sales of discounts and rights to discounts; inciting customer behavior by requirements on how the discount can be redeemed; delivering largest discount to consumers without the requiring the consumer to collect points or wait for other loyalty program parameters to be met before obtaining a discount; and delivering discounts based on the consumer purchasing a discount or right to a discount without requiring group participation

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. An internet-enabled retailing system, said system including:
a coupon option server receiving a coupon option representing a discount on a product, wherein said discount is purchasable by a consumer for a coupon option purchase price;
a coupon option database receiving said coupon option from said coupon option server and storing said coupon option; and
a coupon option website receiving said coupon option, displaying said coupon option, and allowing a user to purchase said coupon option.

2. The system of claim 1 wherein said coupon option includes a parameter identifying a time when said coupon option is redeemable at a retailer.

3. The system of claim 1 wherein, upon purchase of said coupon option by said user, data representing said coupon is transmitted from said coupon option server to said user.

4. The system of claim 1 further including a retailer payment system, wherein, upon purchase of said coupon option by said user at said coupon option purchase price, said retailer payment system directs a portion of said coupon option purchase price to said retailer.

5. The system of claim 1 wherein said coupon option website displays a plurality of coupon options that are selectable by said user;

6. The system of claim 5 wherein said plurality of coupon options are searchable by said user by at least one of price, product, location, and time.

7. An internet-enabled redemption system, said system including:
a retailer point of purchase system receiving an identifying code from a consumer, wherein said identifying code is associated with a coupon option representing a discount on a product, wherein said discount is purchased by said consumer for a coupon option purchase price;
a coupon option server receiving said identifying code from said retailer point of purchase system over the internet; and
a coupon option database storing a plurality of coupon options, each associated with an identifying code,
wherein said coupon option server searches said coupon option database for said identifying code and returns to said retailer point of purchase system a coupon option associated with said identifying code,
wherein said retailer point of purchase applies said coupon option to a purchase being made by said consumer at said retailer point of purchase.

8. The system of claim 7 wherein said coupon option includes a parameter identifying a time when said coupon option is redeemable at a retailer.

9. The system of claim 7 wherein, upon purchase of said coupon option by said user, data representing said coupon is transmitted from said coupon option server to said consumer.

10. The system of claim 7 further including a retailer payment system, wherein, upon purchase of said coupon option by said user at said coupon option purchase price, said retailer payment system directs a portion of said coupon option purchase price to said retailer.

11. A wireless broadcast retailing system, said system including:
a coupon option server receiving a coupon option representing a discount on a product, wherein said discount is purchasable by a consumer for a coupon option purchase price;
a coupon option database receiving said coupon option from said coupon option server and storing said coupon option;
a retailer wireless broadcast device receiving said coupon option and wirelessly broadcasting said coupon option at a retailer site; and
a wireless consumer device, wherein said wirelessly broadcast coupon option is receivable by a consumer device, wherein said wireless consumer device includes a coupon option application that displays said coupon option for said consumer and allows said consumer to purchase said coupon option.

12. The system of claim 11 wherein said coupon option includes a parameter identifying a time when said coupon option is redeemable at a retailer.

13. The system of claim 11 wherein, upon purchase of said coupon option by said user, data representing said coupon is transmitted from said coupon option server to said wireless consumer device.

14. The system of claim 11 further including a retailer payment system, wherein, upon purchase of said coupon option by said user at said coupon option purchase price, said retailer payment system directs a portion of said coupon option purchase price to said retailer.

15. The system of claim 11 wherein said coupon option application displays a plurality of coupon options that are selectable by said user;

16. The system of claim 15 wherein said plurality of coupon options are searchable by said user by at least one of price, product, location, and time.
